(19) United States
(12) Patent Application Publication
(10) Pub. No.: US 2008/0315654 A1
(43) Pub. Date: Dec. 25, 2008

(54) Vehicle Seat

(76) Inventors: Richard Boudinot, Dusseldorf (DE); Michael Fahl, Overath (DE); Glen Lee, Koln (DE); Ingo Kienke, Wermelskirchen (DE); Frank Weber, Odenthal (DE); Karthikeyan Maharajapuram S., Burscheid (DE)

Correspondence Address: BUTZEL LONG;IP DOCKETING DEPT, 350 SOUTH MAIN STREET, SUITE 300, ANN ARBOR, MI, 48104, US

(21) Appl. No.: 12/066,037

(22) PCT Filed: Aug. 25, 2006
(86) PCT No.: PCT/EP2006/008334

§ 371 Date: Aug. 13, 2008

(30) Foreign Application Priority Data
Sep. 9, 2005 (DE) 10 2005 043 254.9
Apr. 28, 2006 (DE) 10 2006 020 370.4

(51) Int. Cl. B60N 2/20

(52) U.S. Cl. 297/378.1

(57) ABSTRACT

A vehicle seat (1) is provided with a seat part (2) and a backrest (3), which may be folded from a substantially upright position of use (G) by the action of a spring device (6) into a substantially horizontal loading position (L), a spring force (F1) oriented in the direction of the loading position or a correspondingly oriented torque (M1) being able to be generated when folding forward from the position of use into the loading position by means of the spring device until reaching an intermediate position (A). According to the invention it is provided that a spring force (F2) oriented counter to the direction of the loading position (L) or a corresponding torque (M2) may be generated by means of the spring device (6) when the intermediate position (A) has been passed.

The invention relates to a vehicle seat comprising a seat part and a backrest, which may be folded from a substantially upright position of use by the action of a spring device into a substantially horizontal loading position, a spring force oriented in the direction of the loading position and/or a correspondingly oriented torque being able to be generated when folding forward from the position of use into the loading position by means of the spring device, until reaching an intermediate position.

### PRIOR ART

A generic vehicle seat is known from the German patent application DE 10 2004 002 795 A1. In this vehicle seat, a spring device assists the folding forward of the backrest only as far as an intermediate position.

Subsequently, the spring is uncoupled, so that only the gravitational force of the backrest acts in the direction of the loading position.

### OBJECT

The object of the invention is to improve further the control of the movement sequence when folding forward the backrest from the position of use into the loading position.

### Solution

The object is achieved according to the invention in that a spring force oriented counter to the direction of the loading position or a corresponding torque may be generated by means of the spring device when said intermediate position has been passed.

The spring device thus generates in the loading position of the backrest a second torque acting thereon in the direction of the position of use, oriented counter to the first torque acting in the direction of the loading position. Thus when folded forward the backrest is retained by the spring device in an intermediate position and subsequently has to be pivoted against the resistance of the spring device into the loading position and is locked in this position. After releasing the locking, the backrest automatically pivots back as a result of the spring force into the intermediate position and may be gripped manually at that point without difficulty and folded back into the position of use.

The sub-claims refer to preferred embodiments of the invention.

### FIGURES

The figures represent, by way of example and schematically, different embodiments of the invention, in which:

FIG. 1 shows a vehicle seat according to the invention in different positions,

FIG. 2 shows a view of a spring device suitable for carrying out the invention,

FIG. 3 shows a representation of the torques generated by said spring device,

FIG. 4 shows a further vehicle seat according to the invention,

FIG. 5 shows a vehicle seat according to a further embodiment of the invention in different positions,

FIG. 6 shows the path of the spring forces when folding forward the backrest.

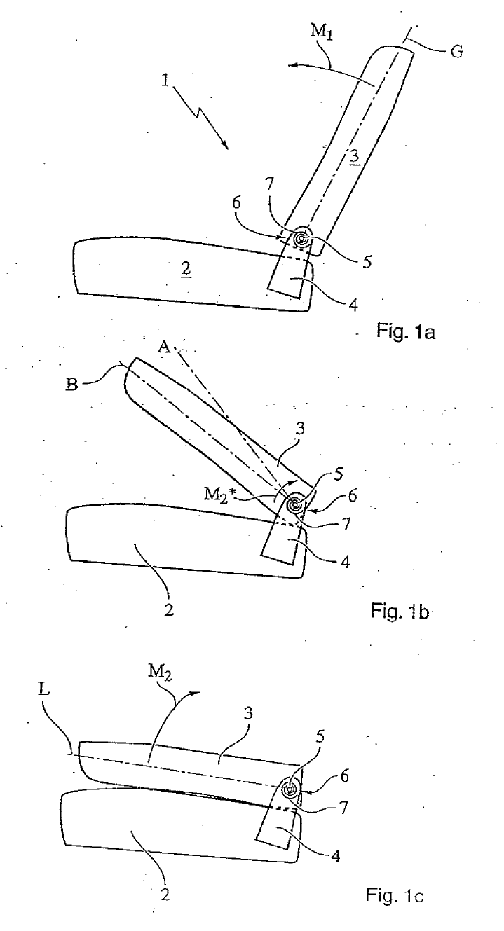

The vehicle seat 1 illustrated in FIG. 1 consists of a seat part 2 and a backrest 3, which is connected to the seat part 2 via an inclination adjuster 4 about a horizontal rotational axis 5 extending transversely to the seating direction.

The backrest 3 may be folded, after releasing a latching device in the inclination adjuster 4, from its upright position of use G (FIG. 1a) forward onto the seat part 2 into an approximately horizontal loading position L (FIG. 1c) and may be locked in this position again by the inclination adjuster 4 (or any other device).

In the region of the rotational axis 5, the inclination adjuster 4 comprising a spring device 6 is provided with a separate spring element 6.1 in the form of a spiral spring 7 (FIG. 2), the internal end 8 thereof being connected fixedly in terms of rotation to the backrest 3 and the external end 9 thereof, at a distance from the rotational axis 5, being connected fixedly to the inclination adjuster 4. The spiral spring 7 is thus pretensioned such that, in the position of use G of the backrest 3, it generates a first torque M1 acting forward in the direction of the loading position L thereof and in the loading position L of the backrest 3 it generates an opposingly oriented torque M2. When folding forward the backrest 3, the spiral spring 7 thus passes through a first intermediate position A in which it is without tension. When folded forward, as a result of its dead weight, the backrest 3 remains briefly in a second intermediate position B which is pivoted forward slightly in the direction of the loading position L relative to the intermediate position A, as a result of gravitational force. At the same time, in the spiral spring 7 a restoring torque M2* has already been created which (disregarding frictional forces) compensates for the dead weight of the backrest 3.

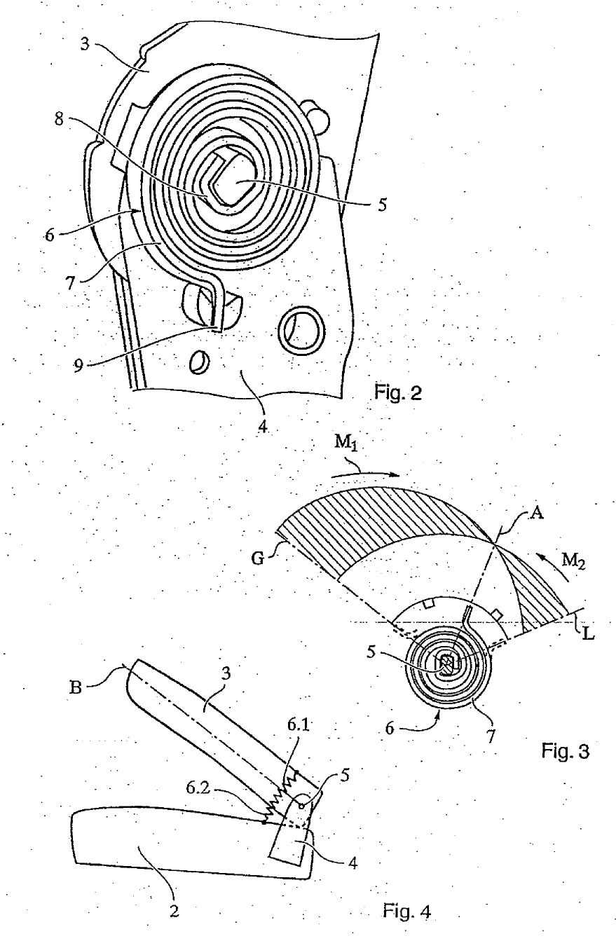

Instead of a spring element 6.1 acting in both rotational directions, two specific spring elements 6.1 and 6.2, as shown in FIG. 4, may also be used which together have the spring characteristic shown in FIG. 3, the spring element 6.1 in the position of use of the backrest 3 generating the torque M1 and the spring element 6.2 in the loading position of the backrest 3 generating the restoring torque M2. In the intermediate position A, the resulting torque generated by the spring elements 6.1 and 6.2 is exactly zero, both torques M1, M2, respectively adopting the value zero or, however, being compensated, the torque M1 therefore being the same as the torque M2 but in the opposing rotational direction.

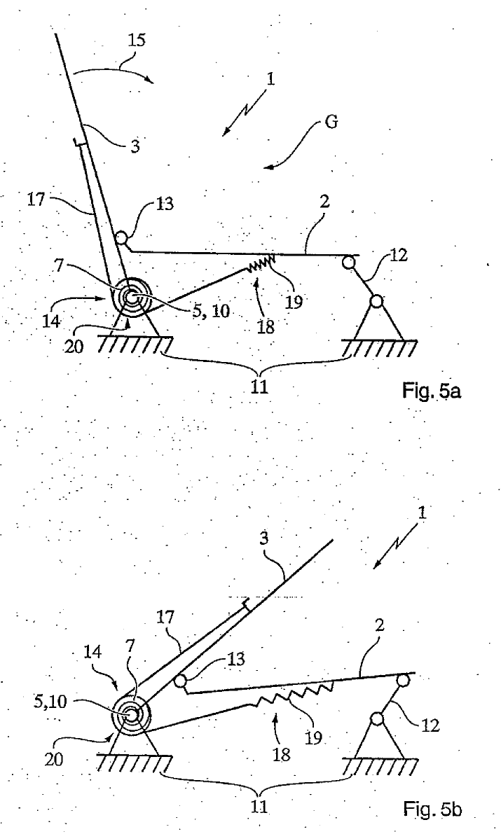

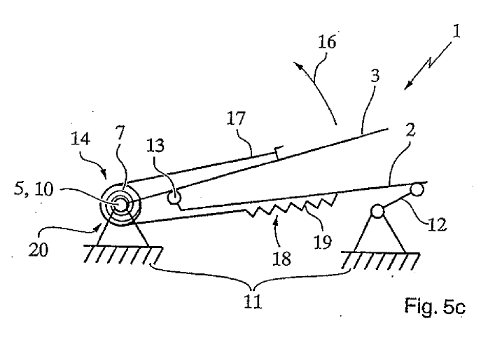

In the vehicle seat 1 shown in FIG. 5a, the backrest 3 is pivotably connected directly to the vehicle floor 11 at its lower end via a joint 10 with a rotational axis 5. The seat part 2 is articulated at its front end via an articulated arm 12 to the vehicle floor 11 and is rotatably arranged on the backrest 3 at its rear end by means of a further joint 13 located above the joint 10. When folding forward the backrest 3 from its approximately perpendicular position of use G according to FIG. 5a, into the approximately horizontal loading position L according to FIG. 5c, the seat part 2 is forcibly displaced forward and downward.

In the region of the joint 10, a first spring element 14 already acts in the form of a spiral spring 7 such that in the position of use G of the backrest 3 it generates a force F1 (arrow 15) oriented to the front in the direction of the loading position L and in the loading position it generates a force F2 (arrow 16) oriented to the rear in the direction of the position of use. It is understood that the spring forces F1, F2 acting on the rotatable backrest 3 generate a corresponding torque M1, M2 about the rotational axis 5. The terms are intended, therefore, to be regarded as synonymous within the meaning of the present invention. By means of a flexibly slack transmission element 17, moreover, a further spring element 18, in particular a rubber cord 19, is arranged between the backrest 3 and the seat part 2. The transmission element 17 is fastened in the upper region of the rear face of the backrest 3 and is deflected about a rotationally fixed, rod-like deflector 20 in the region of the joint 10 by approximately 90° in the direction of the underside of the seat part 2. At this point it is connected with its free end to the rubber cord 19, the other end thereof being in turn fastened to the underside of the seat part 2.

In the position of use of the backrest 3, the rubber cord 19 is almost untensioned. The folding forward of the backrest 3 which is initially assisted by the spiral spring 7, leads to a tensioning of the rubber cord 19 and thus to generating a force oriented counter to the folding forward F2. When reaching the intermediate position A according to FIG. 5b, said counter force cancels the force F1 and/or the torque of the spiral spring 7 (F RES=F1+F2=0) so that only the weight of the backrest 3 acts in the direction of the loading position L. With a further folding forward, the effective direction of the spiral spring 7 is also reversed, so that the backrest 3 finally adopts its loading position L according to FIG. 5c almost without force. The spring device 6 compensates, therefore, for the weight of the backrest 3 only in the loading position. A position corresponding to the intermediate position B in FIG. 1b, therefore, is not present in said vehicle seat.

In this process, the transmission element 17 which, for example, is formed from an overhanging portion of a rear textile cover of the backrest 3, slides over the deflector 20 and generates at that point a sliding friction which additionally dampens the movement sequence.

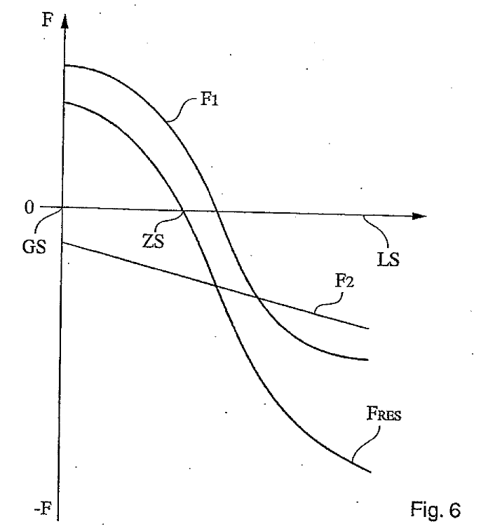

FIG. 6 shows the path of the resulting spring force F RES when folding forward the backrest 3, the forces F1 of the first spring element 14 and the forces F2 of the second spring element 18 being canceled in the intermediate position A. When reaching the loading position L the resulting spring force F RES corresponds at most to the weight (not shown) of the backrest 3, but is oriented counter thereto.

List of reference numerals

| | |
|---|---|
| 1 | Vehicle seat |
| 2 | Seat part |
| 3 | Backrest |
| 4 | Inclination adjuster |
| 5 | Rotational axis |
| 6 | Spring device |
| 6.1, 6.2 | Spring element |
| 7 | Spiral spring |
| 8 | Internal end (of the spiral spring) |
| 9 | External end (of the spiral spring) |
| 10 | Joint |
| 11 | Vehicle floor |
| 12 | Articulated arm |
| 13 | Joint |
| 14 | Spring element |
| 15 | Arrow (direction of force F1) |
| 16 | Arrow (direction of force F2) |
| 17 | Transmission element |
| 18 | Spring element |
| 19 | Rubber cord |
| 20 | Deflector |
| M1, M2, M2* | Torques |
| F1, F2, F RES | Forces |
| G | Position of use |
| L | Loading position |
| A | Intermediate position (compensating for |
| | spring forces) |
| B | Intermediate position (taking into |
| | account weight of backrest) |

1. A vehicle seat comprising:
a seat part and a backrest, which may be folded from a substantially upright position of use by the action of a spring device into a substantially horizontal loading position, a first spring force oriented in the direction of the loading position or a first correspondingly oriented torque being able to be generated when folding forward from the position of use into the loading position by means of the spring device until reaching an intermediate position,
wherein a second spring force oriented counter to the direction of the loading position or a second corresponding torque may be generated by means of the spring device when the intermediate position has been passed; and
wherein the seat part at its rear end is rotatably connected to the backrest by means of a joint and during the folding forward thereof may be lowered.

2. The vehicle seat of claim 1, wherein a second spring force oriented in the direction of the position of use or a second corresponding torque may be generated when folding back the backrest from the loading position into the position of use by means of the spring device until reaching an intermediate position; and wherein a first spring force oriented counter to the direction of the position of use or a first corresponding torque may be generated when the intermediate position has been massed.

3. The vehicle seat of claim 1, wherein the spring device comprises a first spring element having a spiral spring which acts in a joint of the backrest.

4. The vehicle, of claim 3, wherein both first and second spring forces or first and second torques may be generated from a spring element acting in both directions.

5. The vehicle seat of claim 3, wherein the spring device comprises a second spring element having a rubber cord, which at one end is connected to the backrest of the vehicle seat via a preferably flexibly slack transmission element.

6. of claim 5, wherein as a result of the transmission element and/or the second spring element when folding forward the backrest a frictional force may be generated in the region of the rotational axis.

7. The vehicle seat of claim 6, wherein the second spring element is connected to the seat part at the other end thereof.

8. The vehicle seat of claim 1, wherein the backrest is connected to the seat part via an inclination adjuster about a horizontal rotational axis extending transversely to the seating direction.

9. The vehicle seat of claim 1, wherein the backrest is pivotally connected directly to a vehicle floor at its lower end via a joint with a rotational axis.

10. The vehicle seat of claim 1, wherein the seat part is articulated at its front end via an articulated arm to a vehicle floor and is rotatably arranged on the backrest at its rear end by means of a further joint located above the joint.

11. The vehicle seat of claim 1, wherein a transmission element is fastened in the upper region of the rear face of the backrest and is deflected about a rotationally fixed, rod-like deflector in the region of a joint by approximately 90° in the direction of the underside of the seat part.
